(19) United States
(12) Patent Application Publication
(10) Pub. No.: US 2004/0206738 A1
(43) Pub. Date: Oct. 21, 2004

(54) MAMMOGRAPHY PATIENT CONTACT TEMPERATURE CONTROLLER

(75) Inventors: Andrew Scott Argersinger, Colgate, WI (US); Jonathan Mark Butzine, Oconomowoc, WI (US); Christine Quong, Pewaukee, WI (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY COMPANY, LLC, Waukesha, WI (US)

(21) Appl. No.: 10/709,973

(22) Filed: Jun. 10, 2004

Related U.S. Application Data
(63) Continuation-in-part of application No. 09/683,434, filed on Dec. 28, 2001.

(51) Int. Cl. H05B 3/00; G21K 5/10

(52) U.S. Cl. 219/217

(57) ABSTRACT

A mammography imaging assembly is provided comprising an imaging frame assembly, a imaging signal generation assembly mounted to the imaging frame, and an imaging detector bucky mounted to the imaging frame assembly. The imaging detector bucky comprises a patient exposure surface facing the imaging signal generation assembly. A thermo sensor assembly is positioned to monitor temperature at the patient exposure surface. A thermo generating element is in thermal communication with the patient exposure surface. A logic is in communication with the at least one thermo sensor assembly and the thermo generating element such that it controls heat generated by the thermo generating element and the temperature of the patient exposure side is controlled. A compression paddle is movably positioned between the imaging signal generation assembly and the imaging detector bucky.

### CROSS REFERENCE TO RELATED APPLICATIONS

This application is a continuation-in-part of application Ser. No. 09/683,434 entitled “Heated Patient Diagnostic Table” and filed on Dec. 28, 2001.

### BACKGROUND OF INVENTION

The present invention relates generally to a mammography screening monitor and more particularly to a mammography screening monitor with a temperature controlled patient contact surface.

Modern medical facilities often subject patients to a cold, austere, and sterile environment. While certain aspects of these environments are necessitated by the desire to safeguard a patient's health, others merely serve to increase the discomfort the patients may already be experiencing. The thin gowns worn by patients, while allowing quick and easy access to the patient's body for diagnosis or treatment, often result in exposed skin or lightly covered skin that is vulnerable to the cold surfaces of the medical environment. This exposure can result in discomfort and may undesirably stress the patient. While this is undesirable for any patient, additional concerns may be raised when seriously ill or injured patients are exposed to these added stressors.

In addition to causing general discomfort, cold surfaces within the medical environment may provide additional complications. During examination where patients may need to hold particular positions, cold medical surfaces can act as heat sinks to the human skin and pull heat from the body. This may make it difficult for the patient to remain in the particular position necessary for examination. When the patient must be on the exam table for long periods of time, this increased patient discomfort may further increase exam time by inducing patient motion and thereby requiring repositioning of the patient. In addition, patient movement during imaging can result in undesirable double exposure images. It would therefore, be highly desirable to increase the comfort of such surfaces such that patient comfort discomfort is decreased and examination procedures can be simplified. In stressful examinations such as mammography, patient discomfort can further exacerbate tension.

Although the application of heat to a mammography assembly may on its surface appear to be a straightforward proposition, design constraints associated with medical imaging can present complications for the use of many heating methodologies. Electrical coils, for example, may result in electrical interference with some imaging technologies. Other technologies may absorb x-rays or other imaging signals and thereby prove impractical. Additionally, even inert heating methodologies such as fluid flow may prove impractical by requiring noisy and bulky pumping systems. Furthermore, the ability to retrofit existing diagnostic tables may be hampered by the use of complex bulky designs. Non-interference, small profile, low cost, and the ability to retrofit can be important design considerations for a heated medical diagnostic table.

It would, therefore, be highly desirable, to have a heated me mammography imaging assembly having a heating element with a relatively small profile, that did not interfere with medical imaging signals, and that could be easily retrofitted to existing medical diagnostic tables.

### SUMMARY OF INVENTION

It is, therefore, an object of the present invention to provide a cost effective, non-interfering, heat generating mammography imaging assembly for improved patient comfort.

In accordance with the objects of the present invention a mammography imaging assembly is provided comprising an imaging frame assembly, a imaging signal generation assembly 14 mounted to the imaging frame, and an imaging detector bucky mounted to the imaging frame assembly. The imaging detector bucky comprises a patient exposure surface facing the imaging signal generation assembly 14. A thermo sensor assembly is positioned to monitor temperature at the patient exposure surface. A thermo generating element is in thermal communication with the patient exposure surface. A logic is in communication with the at least one thermo sensor assembly and the thermo generating element such that it controls heat generated by the thermo generating element and the temperature of the patient exposure side is controlled. A compression paddle is movably positioned between the imaging signal generation assembly 14 and the imaging detector bucky.

Other objects and features of the present invention will become apparent when viewed in light of the detailed description of the preferred embodiment when taken in conjunction with the attached drawings and appended claims.

### BRIEF DESCRIPTION OF DRAWINGS

FIG. 1 is an illustration of an embodiment of a mammography imaging assembly in accordance with the present invention;

FIG. 2 is a detail illustration of an imaging detector bucky for use in the mammography imaging assembly illustrated in FIG. 1;

FIG. 3 is a detail illustration of an alternate imaging detector bucky for use in the mammography imaging assembly illustrated in FIG. 1;

FIG. 4 is an illustration of a mammography imaging assembly in accordance with the present invention, the mammography imaging assembly showing a nonradiolucent cover in the warming position;

FIG. 5 is an illustration of the mammography imaging assembly illustrated in FIG. 4, the mammography imaging assembly illustrated in the imaging position;

FIG. 6 is an illustration of a radiolucent cover for use in the imaging detector bucky shown in FIG. 3;

FIG. 7 is a side-view illustration of the radiolucent cover shown in FIG. 6; and

FIG. 8 is a side-view illustration of an alternate embodiment of the radiolucent cover shown in FIG. 7.

### DETAILED DESCRIPTION

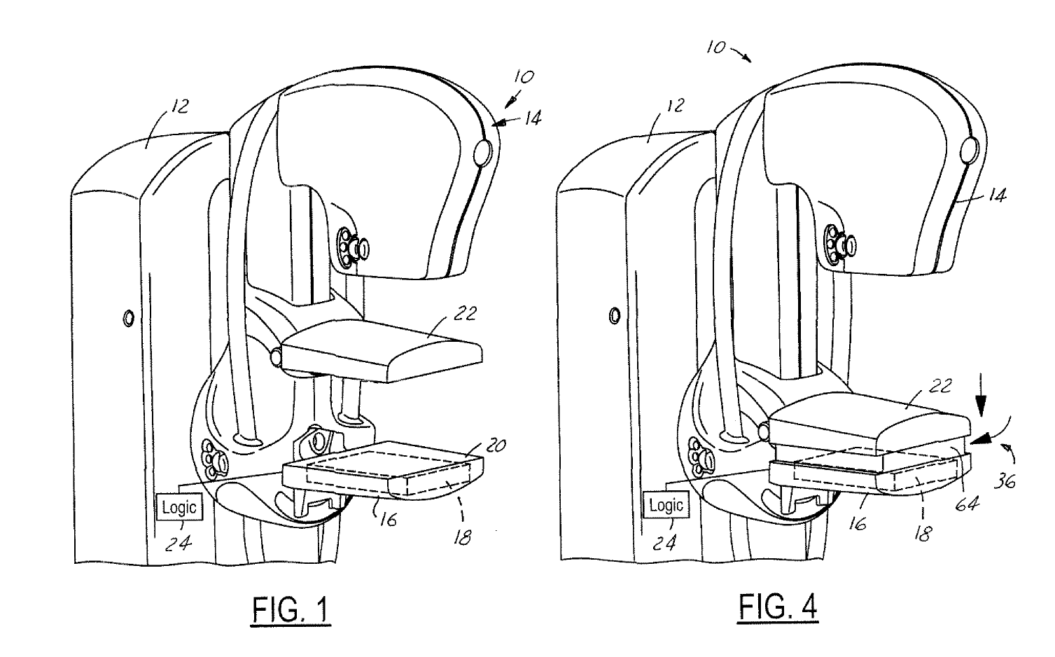

Referring now to FIG. 1, which is an illustration of a mammography imaging assembly 10 in accordance with the present invention. It is well known that mammography imaging assemblies 10 come in a variety of shapes and forms. The configuration illustrated in FIG. 1 is simply for illustrative purposes and is not intended to serve as a limitation on the present invention. The central portions of the mammography imaging assembly 10, however, include an gantry frame assembly 12, a imaging signal generation assembly 14, and an imaging detector bucky 16. These components are commonly utilized in mammography applications. The gantry frame assembly 12 is intended to include a wide variety of support structures. The imaging signal generation assembly 14 is intended to include any assembly generating an imaging signal such as x-rays. The imaging detector bucky 16 is the detector assembly to process the imaging signals from the imaging signal generation assembly 14 such that they can be processed into diagnostic images as known in the art. Although this may be accomplished in a wide variety of fashions, one embodiment contemplates the use of a digital x-ray detector 18 removably positioned within the imaging detector bucky 16 for receiving the imaging signals. A patient's appendage is positioned on the patient exposure surface 20 of the imaging detector bucky 16 and the imaging signal generation assembly 14 is activated. A compression paddle 22 may be moved down onto the appendage to insure proper patient positioning. The x-rays pass through the appendage on the way to the detector bucky 16 thereby leaving an image on the digital x-ray detector 18. A processor logic 24 in communication with the imaging signal generation assembly 14 can be utilized to control gantry 14 activation.

A common problem is generated by the patient exposure surface 20 being well below body temperature during patient position and imaging. As stated, this can negatively affect patient comfort and disposition. Standard heating methodologies, however, can pose an interference with imaging functions. The present invention addresses these concerns by including a thermo generating element 26 in communication with the patient exposure surface 20. The thermo generating element 26 is generates thermal energy such that the patient exposures surface 20 may be raised to body temperature. This provides the patient with optimal comfort during positioning and imaging. Proper temperature is achieved through the use of one or more thermo sensor assemblies 28 positioned on the patient exposure surface 20 such that the sensors 28 can measure actual temperature at the patient exposure surface 20. By placing the sensors 28 and the thermo generating element 26 in communication with the logic 24 the present invention allows the temperature of the patient exposure surface 20 to be accurately controlled. This optimizes patient comfort while preventing overheating.

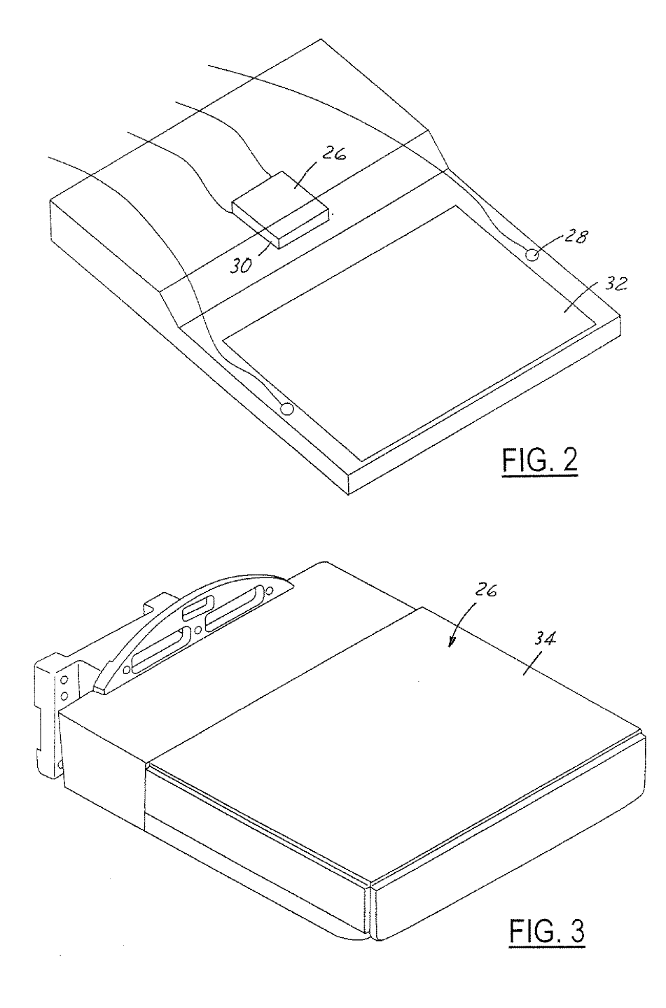

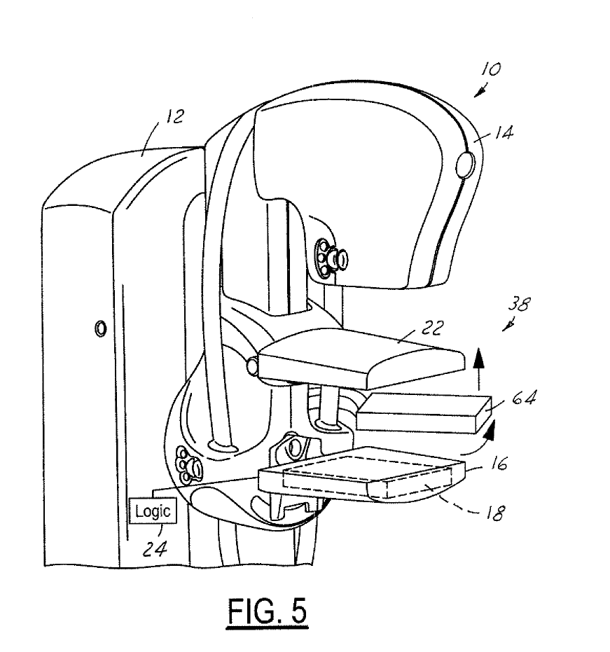

Although a variety of thermo generating elements 26 are contemplated, one embodiment contemplates the use of a thermo electric element 30 positioned within the imaging detector bucky 16 (see FIG. 2). By placing the thermo electric element 30 internally within the bucky 16 the heat generated is naturally dissipated throughout the patient exposure surface 20. It should be understood, however, that mounting the thermo electric element 30 underneath the bucky 16 may be effective as well while providing retrofit possibilities on existing mammography devices. The thermo electric element 30 is preferably in communication with the logic 24 such that current or power to the thermo electric element 30 can be cut prior to activation of the gantry 14 such that any interference generated by the thermo electric element 30 activation is removed prior to imaging. The thermo electric element 30 and the sensors 28 are preferably positioned outside the imaging region 32 of the imaging detector bucky 16 such that imaging interference is minimized.

In an alternate embodiment, the thermo generating element 26 may take the form of a radiolucent cover 34 surrounding the imaging detector bucky 16 or at a minimum the patient exposure surface 20 (see FIG. 3). A wide variety of heating components may be included in the radiolucent cover 34 provided they pose no interference with the imaging signal x-rays (hence radiolucent). It is contemplated that some heating assemblies may only be radiolucent when inactive. In such embodiments, it is again contemplated that the logic 24 be adapted to inactivate the radiolucent cover 34 prior to activation of the gantry 14. Thus the patient exposure surface 20 may again be maintained at the proper body temperature (or slightly warmer) without generating imaging interference. As the compression paddle 22 also makes contact with the patient, it is desirable to warm it as well. The present invention addresses this without the need for additional thermo generating elements 26 by moving the compression paddle 22 between a warming position 36 (see FIG. 4) where it is in thermal communication with the patient exposure surface 20 and an imaging position 38 where it is positioned remote from the patient exposure surface 20 to allow for patient positioning. In this fashion, a single thermal element 26 can warm both elements 20,22. Additionally, as the compression paddle 22 is in thermal communication with the patient exposures surface 20, the surfaces will be at similar temperatures and the sensors 28 act to report the similar temperatures. This acts to allow a single logic 24 to control both temperatures. In one embodiment, it is contemplated that the logic 24 be adapted to move the compression paddle 22 into communication with the patient exposures surface 20 and then into the imaging position 38 once a suitable temperature has been maintained.

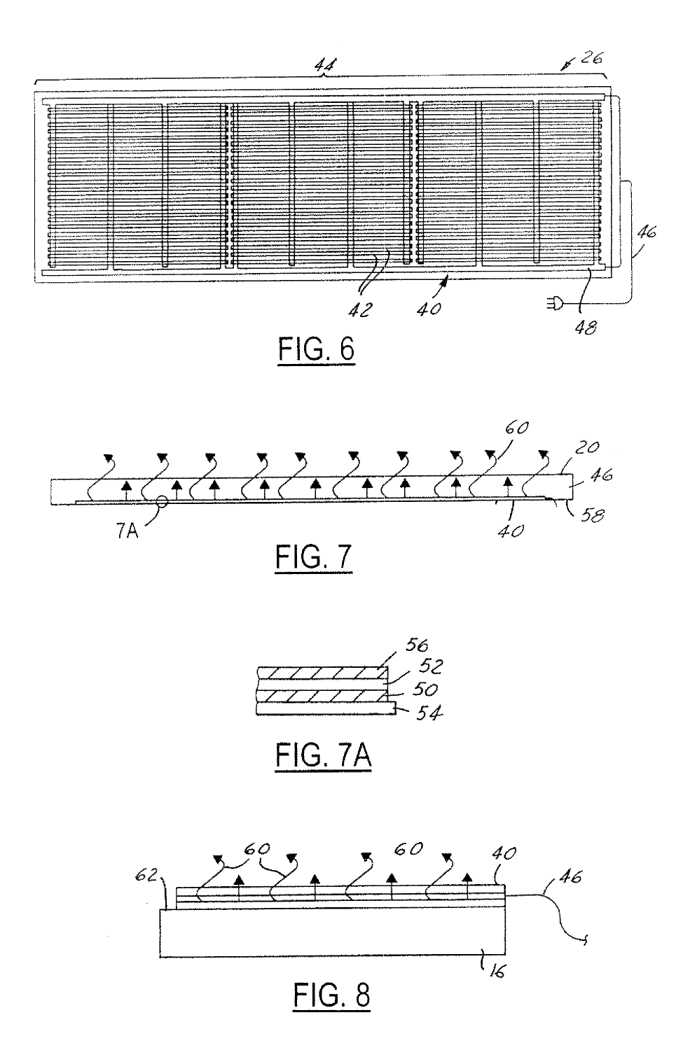

Although a variety of radiolucent covers 34 are contemplated, FIGS. 6-8 indicate several embodiments. Referring now to FIG. 6, which is radiolucent cover 34 in accordance with the present invention. A radiolucent cover 34 includes a heater array 40. The heater array 40 is composed of a conductive polymer coating 42. Although the heater array 40 represents a novel approach to mammography, the use of conductive polymer coatings 42 to create a heater array 40 is well known in non-analogous arts such as automotive heated seat designs, heat skin boots, de-icing antennas, chemical tank heaters, anti-fogging technology, cup warmers, and even stadium cushions. The use of the conductive polymer coating 42 in order to heat the patient exposure surface 20 is highly beneficial in that the technology is well-suited for close contact to skin and can be utilized with the safe voltage and current limits. Even more significantly, the conductive polymer coating 42 does not produce significant image artifacts or absorb a significant amount of x-rays (hence radiolucent), and therefore make them well suited for the low interference characteristics required by mammography imaging.

A wide variety of conductive polymer coatings 42 are known and contemplated by the present invention. In one embodiment, however, the conductive polymer coating 42 includes carbon flakes suspended in a liquid polymer. The flakes can be produced in a certain density such that they overlap by ⅔ and are in layers to create carbon coverage within a printed area. The resistance properties can be varied by varying the concentration of the carbon flake/polymer blend. The conductive polymer coating 42 can then be printed onto a surface and fired. The firing applies heat as is well understood within the art, and can burn off solvents from the liquid polymer and bond the conductive polymer coating 42 to the surface on which it is placed. The printing pattern, as well as the properties of the conductive polymer coating 42 can be utilized to produce a wide variety of heater arrays 40 that are formed in a wide variety of configurations. In addition, although a single form of the conductive polymer coating 42 has been described, a variety of forms and methods of producing a conductive polymer coating 42 are contemplated by the present invention.

Although the conductive polymer coating 42 may be formed in a variety of configurations, in one embodiment it is formed as a grid pattern 44 (see FIG. 60. In another embodiment, the conductive polymer coating can be formed in a continuous pattern. The configuration of the conductive polymer coating 42 can be varied to create anywhere between a sparse and a completely populated heater array 40 and thereby provides flexibility and adaptability for individual designs. As electricity passes through the grid pattern 44 from the power cord 46, the electricity encounters resistance from a conductive polymer coating 42. This, in turn, produces heat. Current may be adjusted or controlled using a variety of techniques and controls well known in the art such that a variety of heating profiles and temperatures may be created. In addition, power may be supplied to the conductive polymer coating 42 in a variety of fashions. In one embodiment, a power cord 46 can be connected to supply power to the conductive polymer coating 42. Additionally, at least one runner 48 can be utilized to transfer current to from the power cord 46, or other power supply, to the conductive polymer coating 42. Runners 48 are preferably thin flat conductive laminates that carry current along the edges of the heater array 40 such that the entire heater array 40 is supplied with power. Although the present invention can be utilized with or without runners 48 and with runners 48 in a variety of positions, one embodiment contemplates the positioning of the runners 48 along the side of the heater array 40. By placing runners 48 along the sides of the heater array 40 it may make it easier to hide the runners 48. This allows the runners 48 to be placed outside the visible area of an x-ray image to minimize interference.

Referring now to FIG. 7, which is a side-view illustration of the heater array 40 illustrated in FIG. 6. Although in its most simplistic form, the heater array 40 can consist solely of a conductive polymer coating 42, additional components may be utilized to improve the mammography imaging assembly 10. The conductive polymer coating 42 can be formed onto a film base 50 such as a polyester film. This creates a flexible and transportable heater array 40 suitable for retrofitting existing diagnostic mammography assemblies. The conductive polymer coating 42 can also be covered with an additional protective film layer 52 for protection. Although, the additional protective film layer 52 may be formed using a variety of materials, in one embodiment the protective film layer 52 is formed using polyester as well. The additional protective film layer 52 can be utilized to prevent damage to the heater array 40 as well as allow the heater array 40 to be mounted to a variety of surfaces without concern for creating electrical shorts.

A reflective element 54 may additionally be included in order to direct the radiant heat produced by the heater array 40 in a direction suitable for usage. Although many configurations are contemplated, in one embodiment the reflective element 54 is utilized to direct heat generated by the heater array 40 up through the patient exposure surface 20. It should be understood that the reflective element 54 is an optional element. As the heater array 40 may be powered by a variety of sources including both d/c and a/c sources, the reflective element 54 may be utilized additionally as a ground. Although the reflective element 54 may be formed using a variety of known materials, it is desirable to form the reflective element to minimize its effect on the attenuation of the imaging signal. In some circumstances, it may be preferable not to use a reflective element 54 where its effect on signal attenuation is undesirable.

A wide variety of optional additional components, such as thermostats, gauges, control modules, and displays may be used in conjunction with the conductive polymer coating 42 in order to further increase the effectiveness of the heat array 40. An adhesive element 56, for example, may also be included to create a convenient mounting methodology to attach the heater array 40 to the imaging detector bucky 16. Although the individual components may be arranged in a variety of fashions, in one embodiment is contemplated that the adhesive 56, the reflector element 54, protective film layer 52, and the film base 50 may be laminated together to create highly effective heating unit suitable for retrofitting onto existing mammography equipment.

It is contemplated that the heat array 40 may be mounted or secured to the imaging detector bucky 16 in a variety of fashions. The optional adhesive 56, as described, allows a convenient method of attachment that may also allow the heat array 40 to be conveniently retrofitted onto existing imaging detector buckys 16. In one embodiment, illustrated in FIG. 7, the heater array 40 is affixed to the bottom surface 58 to the imaging detector bucky 16. In this scenario, thermal energy 60 is radiated up through the imaging detector bucky 16 such that the patient exposures surface 20 can be maintained at a temperature appropriate for skin contact. In an alternate embodiment, illustrated in FIG. 8, the heater array 40 may be on the upper surface 62 of the imaging detector bucky 16. This allows the heater array 14 to be used in even difficult retrofitting situations where access to the bottom surface 38 or a complete surround may not be feasible.

It is understood that the use of radiolucent heating solutions may not always be feasible or cost effective. The present invention, therefore, further contemplates the use of a non-radiolucent element 64 as a thermo generating element 26. The non-radiolucent element 64 is preferably positioned in between the patient exposure surface 20 and the compression paddle 22. Thus when the compression paddle 22 is moved into the warming position 36, both the compression paddle 22 and the patient exposure surface 20 are placed in thermal communication with the non-radiolucent element 64 (see FIG. 4). As the compression paddle 22 is moved into the imaging position 36, however, the non-radiolucent element 64 is automatically moved out of the way such that imaging interference is avoided. Although a variety of mechanical mechanisms for removal of the non-radiolucent element 64 are contemplated, one embodiment contemplates the rotation of the non-radiolucent element 64 out from the path between the gantry 14 and the imaging detector bucky 16. This may be achieved through a variety of simple cam mechanisms or may be placed in control of the logic 24.

While particular embodiments of the invention have been shown and described, numerous variations and alternative embodiments will occur to those skilled in the arm. Accordingly, it is intended that the invention be limited only in terms of the appended claims.

1. A mammography imaging assembly comprising:
a gantry frame assembly;
an imaging signal generation assembly mounted to said imaging frame;
an imaging detector bucky mounted to said imaging frame assembly, said imaging detector bucky comprising a patient exposure surface facing said imaging signal generation assembly;
at least one thermo sensor assembly positioned to monitor temperature at said patient exposure surface;
a thermo generating element in thermal communication with said patient exposure surface;
a logic in communication with said at least one thermo sensor assembly and said thermo generating element, said logic utilizing information from said at least one thermo sensor to control heat generated by said thermo generating element such that the temperature of said patient exposure side is controlled; and
a compression paddle movably positioned between said imaging signal generation assembly and said imaging detector bucky.

2. A mammography imaging assembly as described in claim 1 wherein said thermo generating element comprises a thermo electric element positioned within said imaging detector bucky.

3. A mammography imaging assembly as described in claim 1 wherein said logic is in communication with said imaging signal generation assembly, said logic adapted to remove power from said thermo generating element prior to activating said imaging signal generation assembly.

4. A mammography imaging assembly as described in claim 3 wherein said logic is further adapted to:
lower said compression paddle into thermal communication with said thermo generating element; and
raising said compression paddle prior to activating said imaging signal generation assembly.

5. A mammography imaging assembly as described in claim 1 wherein said thermo generating element comprises a radiolucent cover surrounding said imaging detector bucky.

6. A mammography imaging assembly as described in claim 1 wherein said thermo generating element comprises a non-radiolucent cover surrounding said imaging detector bucky; and
said logic is further adapted to automatically remove said non-radiolucent cover prior to activating said imaging signal generation assembly.

7. A mammography imaging assembly as described in claim 6 wherein said non-radiolucent cover is removed in response to said compression paddle moving away from said imaging detector bucky.

8. A mammography imaging assembly as described in claim 1 wherein said imaging detector bucky comprises an upper bucky surface defining an imaging region, said at least one thermo sensor assembly positioned outside said imaging region.

9. A mammography imaging assembly as described in claim 1 wherein said thermo generating element comprise:
a heater array comprising a conductive polymer coating bonded to a film base, wherein said conductive polymer coating comprises carbon flakes suspended in a liquid polymer.

10. A mammography imaging assembly as described in claim 1 wherein said thermo generating element comprises:
a heater array comprising a conductive polymer coating bonded to a film base and a protective film layer laminated to said film base.

11. A mammography imaging assembly comprising:
an imaging frame assembly;
a imaging signal generation assembly mounted to said imaging frame;
an imaging detector bucky mounted to said imaging frame assembly, said imaging detector bucky comprising a patient exposure surface facing said imaging signal generation assembly;
at least one thermo sensor assembly positioned to monitor temperature at said patient exposure surface;
a thermo generating element in thermal communication with said patient exposure surface; and
a logic in communication with said at least one thermo sensor assembly and said thermo generating element, said logic utilizing information from said at least one thermo sensor to control heat generated by said thermo generating element such that the temperature of said patient exposure side is controlled, said logic in communication with said imaging signal generation assembly, said logic adapted to remove power from said thermo generating element prior to activating said imaging signal generation assembly.

12. A mammography imaging assembly as described in claim 11 further comprising:
a compression paddle movably positioned between said imaging signal generation assembly and said imaging detector bucky.

13. A mammography imaging assembly as described in claim 11 wherein said thermo generating element comprises a thermo electric element positioned within said imaging detector bucky.

14. A mammography imaging assembly as described in claim 11 wherein said thermo generating element comprises a radiolucent cover surrounding said imaging detector bucky.

15. A mammography imaging assembly as described in claim 11 wherein said thermo generating element comprises a non-radiolucent cover surrounding said imaging detector bucky; and
said logic is further adapted to automatically remove said non-radiolucent cover prior to activating said imaging signal generation assembly.

16. A mammography imaging assembly as described in claim 15 wherein said non-radiolucent cover is rotated away from said imaging detector bucky prior to activation of said imaging signal generation assembly.

17. A mammography imaging assembly as described in claim 11 wherein said thermo generating element comprises:
a heater array comprising a conductive polymer coating bonded to a film base, wherein said conductive polymer coating comprises carbon flakes suspended in a liquid polymer.

18. A method of maintaining control of the temperature of a patient exposure surface on an imaging bucky detector as a portion of a mammography imaging assembly comprising:
monitoring the temperature of the patient exposure surface using at least one thermo sensor assembly positioned in communication with patient exposure surface;
reporting said temperature to a logic;
using said logic to control a thermo generating element in response to said temperature such that said temperature can be raised or lowered, said thermo generating element in thermal communication with said patient exposure surface.

19. A method as recited in claim 18 further comprising:
activating a imaging signal generation assembly using said logic; and
cutting power to said thermo generating element prior to activating said imaging signal generation assembly.

20. A method as recited in claim 18 further comprising: activating a imaging signal generation assembly using said logic;
moving a compression paddle into thermal communication with said patient exposure surface prior to use of said imaging signal generation assembly such that thermal energy is transferred from said patient exposure surface to said compression paddle; and
separating said compression paddle from said patient exposure surface prior to use of said imaging signal generation assembly.
